(19) United States
(12) Patent Application Publication
(10) Pub. No.: US 2026/0212253 A1
(43) Pub. Date: Jul. 23, 2026

(54) HIGH SPEED AND HIGH CONSISTENCY REPAIR ACROSS QUANTUM COMPUTING NODES

(71) Applicant: Bank of America Corporation, Charlotte, NC (US)

(72) Inventors: Saurabh Arora, Gurugram (IN); Sandeep Kumar Chauhan, Miyapur Hyderabad (IN); Jhalak Khurana, Hisar Haryana (IN); Anil Gajula, Hyderabad Telangana (IN)

(21) Appl. No.: 19/034,763

(22) Filed: Jan. 23, 2025

(51) Int. Cl. G06N 10/80; G06N 10/70

(52) U.S. Cl. CPC G06N 10/80; G06N 10/70

(57) ABSTRACT

A method for maintaining consistency in an application release for a software application and performing high-speed repair across a cluster of quantum computing nodes is provided. The method may include combining application data associated with the application release into an application bundle and converting the application bundle into a data image. The method may include encrypting the application data. The method may include allocating the cluster of quantum computing nodes for hosting the data image for the application release and entangling the cluster of quantum computing nodes into an entangled state. The method may include releasing the data image to a first quantum computing node, wherein the releasing automatically propagates the data image to each of the quantum computing nodes in the cluster.

### FIELD OF TECHNOLOGY

Aspects of the disclosure relate to providing apparatus and methods for utilizing quantum computing for maintaining and updating application releases across a cluster of nodes.

### BACKGROUND OF THE DISCLOSURE

When software applications are deployed by a company, the company typically makes changes, updates and repairs to the software over time. These changes update the application, either with incremental changes or with a version update.

Although changes have been made, companies typically maintain multiple versions of outdated versions of software applications for resiliency and backup purposes for a predetermined amount of time. When an updated version is deployed to the company's computers, errors may occur. In such cases, the stored versions of the older applications are available if needed to correct the errors.

Companies may deploy multiple clusters of servers for hosting the company's applications. Each cluster of servers may host both a current version of the application and older versions of the application. Managing the current versions of the application releases on all the servers is both difficult and prone to error, due to both the sheer number of the servers and errors that may be generated on a single server and can easily go unnoticed.

It would be desirable, therefore, to have systems and methods for ensuring the consistency of applications run on a cluster of servers. It would be further desirable to use servers to create a cluster of nodes and then entangle the cluster of nodes using quantum entanglement, to support high-speed repair of application errors and to ensure application consistency for all the servers.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative block diagram in accordance with principles of the disclosure.

FIG. 2 shows an illustrative apparatus that may be configured in accordance with principles of the disclosure.

FIG. 3 shows an illustrative architecture diagram in accordance with principles of the disclosure.

FIG. 4 shows an illustrative diagram in accordance with principles of the disclosure.

FIG. 5 shows an illustrative diagram in accordance with principles of the disclosure.

FIG. 6 shows an illustrative diagram in accordance with principles of the disclosure.

FIG. 7 shows an illustrative diagram in accordance with principles of the disclosure.

FIG. 8 shows an illustrative diagram in accordance with principles of the disclosure.

FIG. 9 shows an illustrative diagram in accordance with principles of the disclosure.

### DETAILED DESCRIPTION OF THE DISCLOSURE

A method for maintaining consistency in an application release for a software application is provided. The method may include performing high-speed repair across a cluster of quantum computing nodes when application errors occur and to ensure application consistency for all the servers when repairing the errors.

Multiple application versions may be deployed for use by clients for an application. Since changes and updates are constantly made on an application, updated releases are deployed.

When a new release for an application is tested and ready for deployment, the new release may be released to a plurality of servers. Each of the plurality of servers may host the application release. The plurality of servers may already be hosting a previous version of the application. Each of the plurality of servers may maintain the previous version of the application and also execute the new release.

Each of the plurality of servers may maintain more than one previous version. Systems may maintain a plurality of previous versions of a software application for numerous purposes. The previous versions may be maintained until the newer releases are tested and deployed successfully. The previous versions may be maintained for companies that prefer an older version of the application.

In some embodiments there may be a set of servers hosting one application release and a different set of servers may be hosting a second application release. Each quantum computing server may be an application server hosting the application release.

Applications running on client computers may communicate with the server(s) hosting the application release.

Following the testing of an application release, the application release may be ready for execution on client computers. The application release may be transmitted to the cluster of quantum computing nodes for hosting the application release.

Prior to deploying the application release to one or more quantum computing servers, the method may include combining the application data associated with the application release into an application bundle.

The application data may include the application source code. The application data may include application guidelines. The application guidelines may be guidelines the developments teams use when designing the application. The application guidelines may include integration patterns, fitment of changes and the impact it has on other components of the application.

The application data may include application requirements. The application requirements may include new features and/or modifications to the existing application release.

The application data may also include application architecture mapping. Application architecture mapping may include identifying any one or more dependencies or impacts the application release has in connection with another application. The mapping may enable determining an impact a change may have on the other connected applications.

Following the combining of the application data, the method may include converting the application bundle into a data image. The data image may be a snapshot of the operating system at its present state. The data image may be a condensed version of the application data. The method may leverage generative artificial intelligence (“GenAI”) for generating the data image.

The method may further include executing an image diffusion routine on the data image. The image diffusion routine may be an algorithm that may encrypt the data. The encrypting may securely lock the application data from being accessed, tampered with or altered without secure authentication. In some embodiments, the image diffusion may be an execution of an encryption algorithm on the application data to encrypt all the data.

The method may further include storing the data image in a database at a central server. The data image may be stored in a system of record (“SOR”). The SOR may be an information storage and retrieval system that stores data on an organizational system or process. The SOR may contain a plurality of data sources and exist at a single location or multiple locations with remote access.

The method may include selecting a cluster of quantum computing nodes for hosting the application release. The cluster of quantum computing nodes may be a plurality of quantum servers. The quantum servers may host one application release. In some embodiments, the quantum servers may host each application release.

The quantum servers may be application servers. Applications running on client computers may access these quantum servers for retrieval of data and for execution of actions on the application.

The method may further include entangling the cluster of quantum computing nodes into an entanglement state.

The method may further include releasing the data image to a first quantum computing node. It should be appreciated that the releasing may automatically propagate the data image to each of the quantum computing nodes in the cluster. In some embodiments, the data image may be released to a first quantum computing node. The releasing may be a ripple effect wherein the first quantum computing node automatically propagates the data image to a second quantum computing node, which then propagates the data image further along the cluster until the data image has been released to each quantum computing node in the cluster.

In another embodiment, the releasing may simultaneously propagate the data image to all the quantum computing nodes in the cluster as a result of the node's quantum entangled state.

Because the nodes are entangled, it should be appreciated that when any update or change to the application release is executed on one quantum computing node, the updates/changes may be instantaneously replicated to all quantum computing nodes in the cluster. The replication of the release to each quantum computing node may be performed without a need for communication with each node thereby accelerating the speed of transfer.

The method may further include monitoring application events associated with the application release after the releasing of the data image. The monitoring may include monitoring the functionality of each application release at a client computing end and at the quantum computing servers end.

In response to the monitoring, the method may include identifying an anomaly at one of the quantum computing nodes. The anomaly may be a result of an error at one of the quantum computing servers. The anomaly may be a result of an error occurring at each of the quantum computing servers.

The anomaly may be an error in the application source code. The anomaly may be a result of the improper manipulation of the application source code. The anomaly may be an error manually introduced to the application source code after the release.

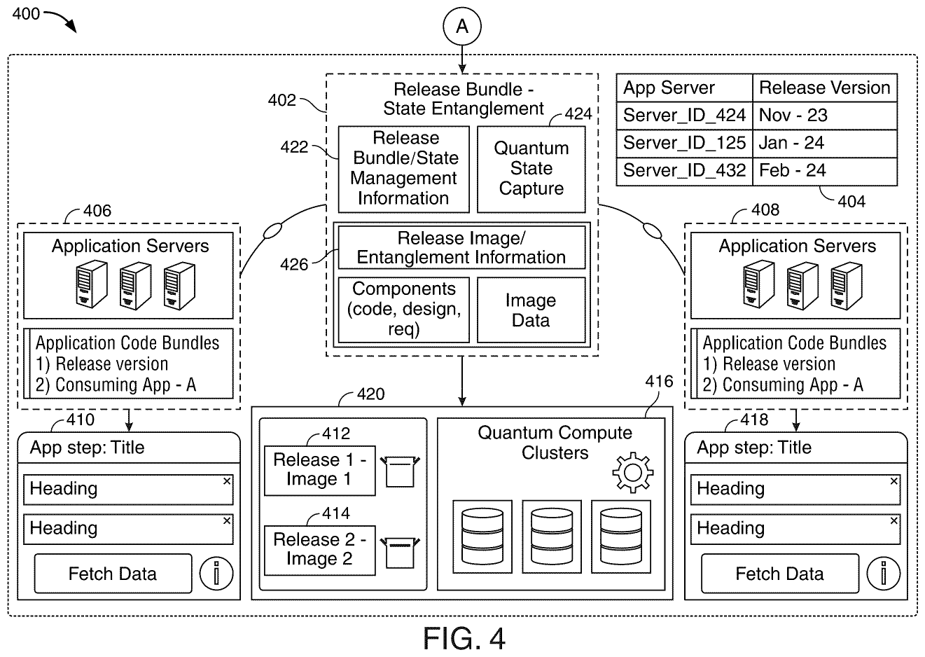

Prior to remediating the anomaly, the method may include re-instating a previous application release at each quantum computing node pending the remediation of the anomaly, as described in FIG. 4 at 420.

When an anomaly is identified at a client computer, the method may include retrieving the data image from the quantum computing node that may be in communication with the client computer.

The method may further include remediating the application data within the data image.

In order to make changes to the application data, the method may include executing a reverse diffusion routine on the data image of the quantum computing node. The reverse diffusion routine may unlock the application data. The reverse diffusion routine may be an execution of a decryption algorithm on the application data to decrypt all the data.

The reverse diffusion routine may be executed following an authentication process. Application data may not be decrypted unless the computing device executing the reverse diffusion routine may be authenticated.

Following the executing, the method may include extracting the application data. In some embodiments, the method may include remediating the anomaly within the application.

In response to the remediating, the method may include instantaneously remediating the anomaly at each quantum computing node within the cluster.

Following the remediating of the anomaly, the method may include converting the application data to a second data image. The second data image may overwrite the data image.

The method may further include re-executing image diffusion on the second data image. The method may further include releasing the second data image to the node. The second data image may overwrite the data image.

It should be appreciated that the releasing of the second data image to the node, may automatically release the second data image to each quantum computing node.

Additionally, as a result of the entangled state of the nodes, when the state of the application release at the node is broken, the state of the of the application release at each quantum computing node may also be broken.

A system for maintaining consistency in each application release for a software application and performing high-speed anomaly repairs across a cluster of quantum computing nodes is provided. The system may include an application release for the software application. The application release may be an updated version of an application. In some embodiments each updated version may be executed as another application release.

The application release may be generated and executed on a central server associated with an entity.

The system may include the cluster of quantum computing nodes for hosting the application release. The cluster of quantum computing nodes may be a plurality of servers allocated for hosting the application release.

Each quantum computing node may include a quantum processing unit. The quantum processing unit may include quantum logic and a quantum register. The quantum logic may include quantum gates and a measurement interface. The quantum gates may include quantum algorithms. The measurement interface may measure a state of each qubit after the qubit is processed by the algorithms.

A measured state may be transmitted to a controller interface configured for enabling information to be transmitted and received between the quantum processing unit and a silicon-based computing device.

The system may also include a central server. The central server may be configured for combining application data including application source code and application architecture associated with the application release into an application bundle.

The central server may be further configured for converting the application bundle into a data image. The data image may be a record of the operating system in its present state.

The central server may also be configured for executing an image diffusion routine on the data image. The image diffusion routine may encrypt the application data.

The central server may be configured for storing the data image in a database.

The central server may also be configured for allocating the cluster of quantum computing nodes for hosting the application release. Following the allocating the cluster, the system may be configured for entangling the cluster of quantum computing nodes into an entangled state.

The system may further be configured for releasing the data image to a first quantum computing node. The releasing may automatically propagate the data image to each of the quantum computing nodes in the cluster.

After the application release, the system may be configured for monitoring application events associated with the application release.

When an anomaly is identified at a quantum computing node from the cluster of quantum computing nodes, the central server may be configured to retrieve the data image from the quantum computing node. The central server may be further configured to execute a reverse diffusion routine on the data image in order to access and repair the application data.

Following the executing, the central server may be configured to extract the application data and remediate a portion of the application source code. The portion may include the anomaly.

The central server may be configured to convert the application data into a second data image. The second data image may replace the data image.

The central server may be configured to re-execute the image diffusion routine on the second data image.

The central server may be configured to release the second data image to one of the quantum computing nodes, wherein the releasing may automatically propagate the second data image to each of the quantum computing nodes.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

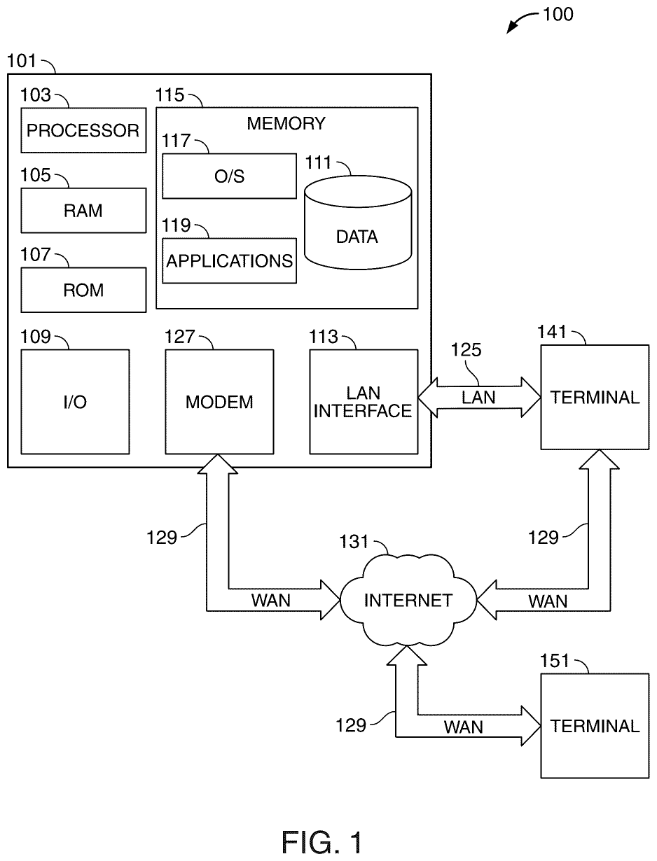

FIG. 1 shows an illustrative block diagram of system 100 that includes computer 101. Computer 101 may alternatively be referred to herein as an “engine,” “server” or a “computing device.” The computing system may include one or more computer servers 101. Computer 101 may be any computing device described herein, such as the central server, each quantum computing node, application servers, client computing devices or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

The memory 115 may be comprised of any suitable permanent storage technology -e.g., a hard drive. The memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all of the elements described above relative to computer 101.

When used in a LAN networking environment, computer 101 is connected to LAN 125 through a LAN interface 113 or an adapter. When used in a WAN networking environment, computer 101 may include a modem 127 or other means for establishing communications over WAN 129, such as Internet 131.

In some embodiments, computer 101 may be connected to one or more other systems via a short-range communication network (not shown). In these embodiments, computer 101 may communicate with one or more other terminals 141 and 151, using a PAN such as Bluetooth®, NFC, ZigBee, or any other suitable personal area network.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may include the release bundle content management tool 312, release data image generation 314, the image diffusion routine 316, reverse diffusion routine 710 and any other applications described herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smart phones, multiprocessor systems, microprocessor-based systems, cloud-based systems, programmable consumer electronics, network PCs, minicomputers, mainframe computers, distributed computing environments that include any of the above systems or devices, and the like.

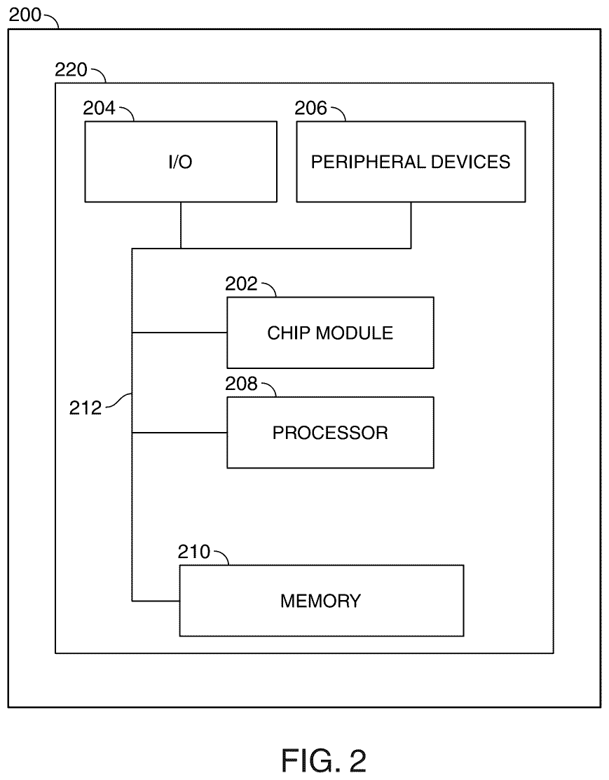

FIG. 2 shows illustrative apparatus 200 that may be configured in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

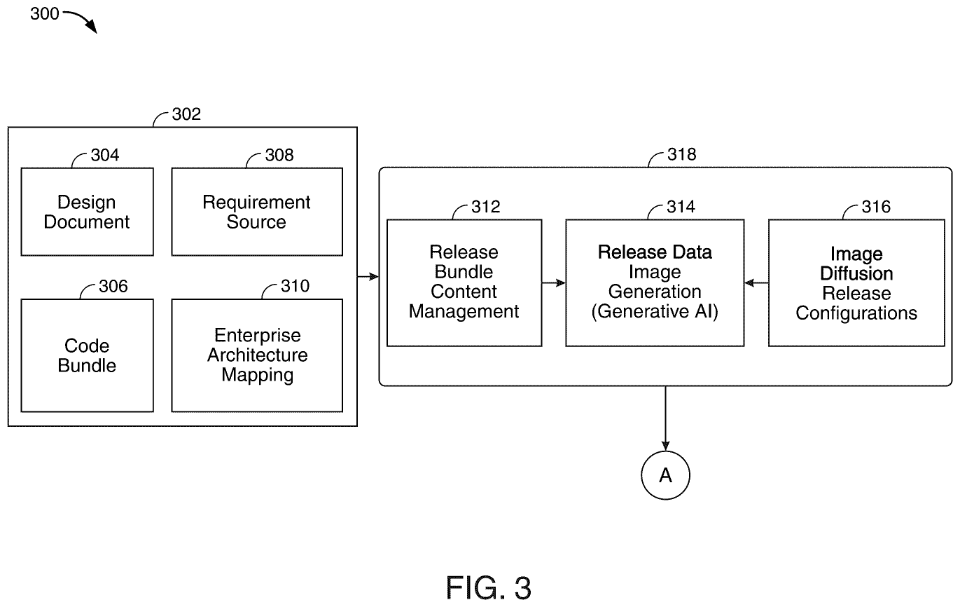

FIG. 3 shows an illustrative diagram 300 in accordance with principles of the disclosure. Diagram 300 may include application data 302. Application data 302 may include data associated with an application release.

For each application release of an application, the system may be configured to combine all the application data. Each release may include new features and components of an application that may be pushed to production. Each release may be developed based on requirements and changes in requirements.

The application data at 302 may include design document 304, code bundle 306, requirement source 308 and enterprise architecture mapping 310.

Design document 304 may include guidelines that may be used by an application development team when designing the application release. Code bundle 306 may include application source code for the application release. The application source code may include changes in the source code that reflect the changes in the requirements and design of the application.

Requirement source 308 may include specific requirements that may have changed or are updated. The changes may include new features to be included in the application and modifications to existing features. The requirement source 308 may include a summarized view of the requirements. The system may leverage a software development tool, i.e.—JIRA, for managing the changes.

Enterprise architecture mapping 310 may include a layout of the application and the additional applications that may be linked to the application. This mapping may enable identifying and monitoring applications that may be linked to the application for determining any impact a change or update may have on all connected and related applications.

In this illustrative diagram 300, following the combining of application data 302, the application data 302 may be converted into a data image, shown at 318. Release bundle content management 312 may be an application tool for combining the application data 302 into a bundle. The bundle may be a data packet. The bundle may include the application data.

At 314, a data image may be generated using GenAI. The data image may be a condensed version of the application data. The data image may be a snapshot of the operating system at its present state.

Following the generating of the data image, an image diffusion routine 316 may be executed on the data image. Image diffusion routine 316 may be an algorithm that may obscure the application data. This may secure the application data from being accessible by an attempted hacker.

FIG. 4 shows an illustrative diagram 400 in accordance with principles of the disclosure. At 402, release bundle state entanglement information may be shown. Release bundle 422 may include the data image and other additional related data. State management information 422 may include information and data associated with managing the quantum state. Release bundle and state management information 422 may also include information associated with managing the application release state.

Quantum state capture 424 may include information and details regarding the quantum state capture. Quantum state capture 424 may include a quantum state of the quantum computing servers. This may include a serial number, a model number or any other suitable data. Release image and entanglement information 426 may include information and data associated with the data image for the application release. Release image and entanglement information 426 may also include entanglement information associated with the entangled quantum computing servers.

Application servers 406 and 408 may be quantum computing servers. Application servers 406 and 408 may be in a quantum entanglement state. Each of the servers may be hosting a single application release. Each of the servers may be hosting more than one application release.

In this exemplary diagram, application servers 406 and 408 may be hosting application release version ‘A’.

As shown at 404, application ‘A’ may have three application releases. Each release may be hosted on a different set of servers. For each application release, a separate data image may be generated as shown at 420. Release 1 may generate image 1, as shown at 412 and release 2 may generate image 2, as shown at 414. The quantum computing clusters 416 may host each application release data image.

When an application is deployed, the application may need to access data from the quantum computing server hosting the application release. At 410 and 418, a request for data may be shown for retrieving data from application servers 406 and 408 which may be hosting the application release.

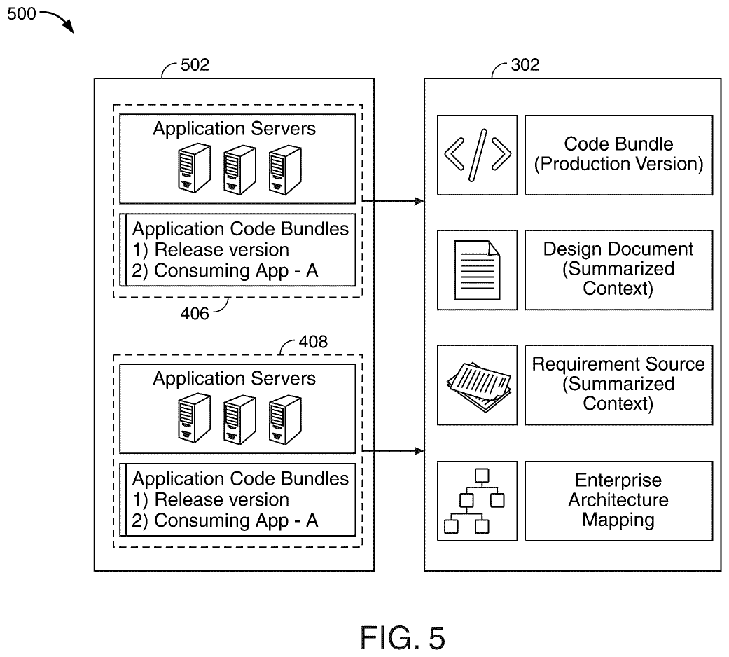

FIG. 5 shows an illustrative diagram 500 of the configurations for generating a data image for an application release to be released to the quantum computing servers. Thereafter, these releases may be accessible by the server(s) when a need arises to rollback to a previous application release.

At 502, application servers 406 and 408, illustrated in FIG. 4, may be allocated for hosting the application release. Application data 302 associated with the application release may be combined as a bundle. Application data 302 may include code bundle, design document, requirement source and enterprise architecture mapping, as described in FIG. 3.

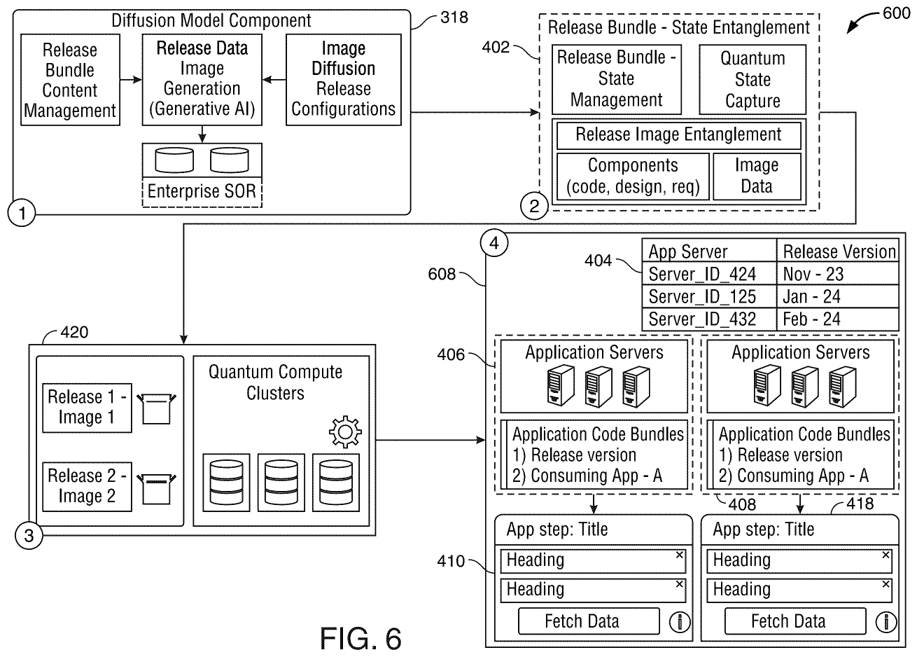

FIG. 6 shows an illustrative diagram 600 in accordance with principles of the disclosure. Diffusion model component 318 may include a plurality of steps for generating the data image for the application release, as described in FIG. 3. The application data may be converted into a data image and an image diffusion routine may be executed for encrypting the application data within the data image thereby securing the application data.

Following the execution of the image diffusion routine, entanglement may be established, as shown at 402. The cluster of nodes that may be allocated for hosting the application release may be entangled. This entanglement may bind the servers for serving the same application release. It should be appreciated that if one node is deviated or touched, then it may affect all of the nodes.

As illustrated at 420, each application release may have a data image. There may be one cluster of quantum computing nodes hosting each application release. There may be a plurality of clusters of quantum computing nodes. Each cluster may host one application release. In some embodiments, each cluster may host each application release.

At 608 application servers 406 and 408 may be hosting application release version ‘A’ as described in FIG. 4.

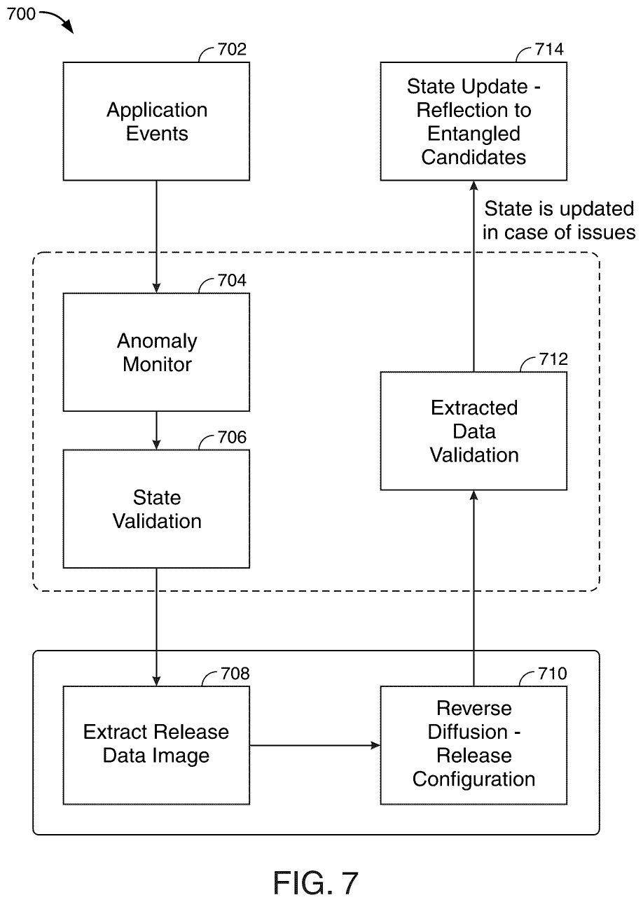

FIG. 7 shows an illustrative flow chart 700 in accordance with principles of the disclosure.

Application events, shown at 702, may include events and actions associated with the application release. At 704, the method step may include monitoring application events being executed in order to be enabled to identify an anomaly(s). An anomaly may be identified by determining an inconsistency between the quantum computing servers, lack of response to a request from an application running on a client computer or any other suitable anomaly. The application events may be monitored at the client side and at the server side.

In response to an identification of an anomaly, the method step may include performing a state validation for repairing the anomaly. State validation 706 may include extracting the data image of the application release from the quantum computing node where the anomaly occurred, as shown at 708. Following the extracting, the method step may include executing a reverse diffusion routine on the data image to decrypt the application data, as shown at 710.

At 712, the method step may include performing a data validation on the extracted application data. The performing of the data validation may include identifying one or more bugs in the application source code and repairing the bugs. The performing of the data validation may include determining an attempted hack on the application source code and securing the application source code and access to the code.

The data validation may include re-instating the previous application release while the anomaly is being repaired. The data validation may include repairing the anomaly. Following the repairing the method may include re-executing the data image to include the updated application data.

At 714, the method step may include releasing the updated data image to the quantum computing node. The releasing of the updated data image may automatically be released to each entangled quantum computing node in the cluster. Because the quantum computing nodes are in an entangled state, when any changes or updates are executed, the changes are reflected instantaneously to all entangled nodes. This enables a high-speed and secure mode of transferring data.

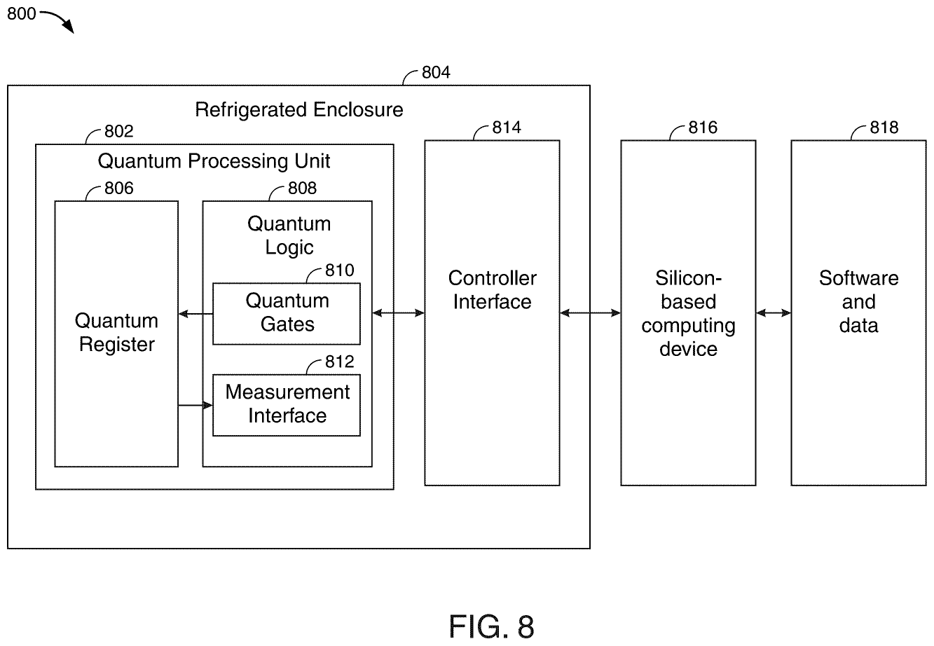

FIG. 8 shows illustrative block diagram of system 800. System 800 may include quantum processing unit 802. Quantum processing unit 802 may be a processing unit that uses quantum principles to perform tasks. Quantum processing unit 802 may include quantum register 806. Quantum processing unit 802 may include quantum logic 808. Quantum logic 808 may include quantum gates 810 and measurement interface 812.

Quantum register 806 may be comprised of qubits. Each qubit may have a state of either zero or one, like a classical bit. However, unlike a classical bit, a qubit may have a superposition state. The superposition state may be a state in which the qubit exists as all possible states simultaneously. In order to maintain the qubits in a superposed state, the qubits are preserved at close to absolute zero degrees (kelvin). Refrigerated enclosure 804 may maintain the qubits at close to absolute zero degrees (kelvin).

Quantum gates 810 may include quantum algorithms, such as algorithms based on amplitude amplification, algorithms based on the quantum Fourier transform, algorithms based on quantum walks and/or any other suitable quantum algorithms. Each algorithm may include a series of one or more quantum gates, such as but not limited to identity gates, Pauli gates, controlled gates, phase shift gates, Hadamard gates, swap gates and Toffoli gates. Measurement interface 812 may measure a state of each qubit after being processed by the algorithms included in quantum gates 810. The measured state of each qubit may be a finite state.

The measured state may be transmitted to controller interface 314. Controller interface 814 may enable information to be transmitted between quantum processing unit 302 and silicon-based computing device 816. The measured state may be transmitted to silicon-based computing device 816. Silicon-based computing device 816 may include software and data 818. Software and data 318 may be used to process the measured state that was transmitted from quantum processing unit 802. Silicon-based computing device 816 may transmit data included in software and data 818 to controller interface 814. Controller interface 814 may transmit the data to quantum processing unit 802 to be processed and analyzed.

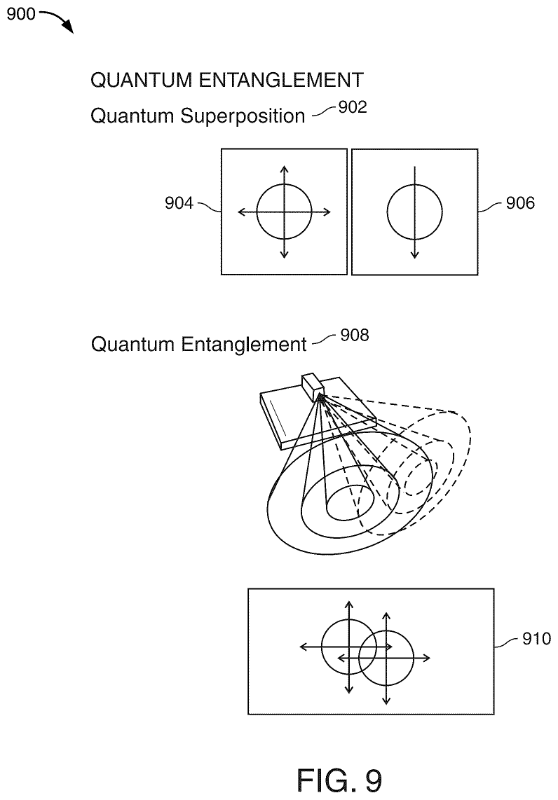

FIG. 9 shows illustrative diagram 900. Illustrative diagram 900 may have one or more features in common with system 900. Illustrative diagram 900 may include quantum superposition, as shown at 902. The rules of quantum physics state that an unobserved quantum particle, such as a photon, exists in all possible states simultaneously, as shown at 904. However, when observed or measured, the quantum particle collapses into one state, as shown at 406 (spin-down).

Quantum entanglement, shown at 908, may occur when two quantum particles become connected. A laser beam fired through a certain type of crystal can cause individual photons to be split into pairs of entangled photons. A pair of entangled particles may be shown at 910.

Thus, systems and methods for maintaining consistency in an application release for a software application and performing high-speed repair across a cluster of quantum computing nodes is provided. Persons skilled in the art will appreciate that the present invention can be practiced by other than the described embodiments, which are presented for purposes of illustration rather than of limitation.

What is claimed is:

1. A method for maintaining consistency in an application release for a software application and performing high-speed repair across a cluster of quantum computing nodes, the method comprising:
combining application data including application source code and application architecture associated with the application release into an application bundle;
converting the application bundle into a data image, the data image being a snapshot of a present state of an operating system (“OS”), the OS managing the software application;
executing an image diffusion routine on the data image, the image diffusion routine encrypting the application data;
storing the data image in a database;
allocating the cluster of quantum computing nodes for hosting the application release;
entangling the cluster of quantum computing nodes into an entangled state;
releasing the data image to a first quantum computing node, wherein the releasing automatically propagates the data image to each of the quantum computing nodes in the cluster;
after releasing the data image, monitoring application events associated with the application release; and
when an anomaly is identified at a quantum computing node from the cluster of quantum computing nodes:
retrieving the data image from the quantum computing node;
executing a reverse diffusion routine on the data image in order to access and repair the application data;
following the executing, extracting the application data;
remediating a portion of the application source code comprising the anomaly;
converting the application data into a second data image;
re-executing the image diffusion routine on the second data image; and
releasing the second data image to one of the quantum computing nodes, wherein the releasing automatically propagates the second data image to each of the quantum computing nodes.

2. The method of claim 1 further wherein the second data image overwrites the data image.

3. The method of claim 1 wherein when the anomaly is identified at the quantum computing node, a state of the application release at the quantum computing node is broken.

4. The method of claim 3 wherein when the state of the application release at the quantum computing node is broken, the state of the application release at each quantum computing node is also broken.

5. The method of claim 4 further comprising, when the state of the application release is broken, the method comprises re-instating a previous application release at each quantum computing node pending the remediating of the anomaly.

6. The method of claim 1 wherein the anomaly is an error in the application source code.

7. The method of claim 1 wherein the image diffusion routine is an algorithm executed on the application data for encrypting the application data.

8. The method of claim 7 wherein the reverse diffusion routine is an application executed on the encrypted application data that decrypts the application data.

9. The method of claim 1 wherein the quantum computing nodes are disentangled when the anomaly is identified.

10. The method of claim 1 wherein the application data further comprises application guidelines and application requirements.

11. A system for maintaining consistency in each application release for a software application and performing high-speed anomaly repairs across a cluster of quantum computing nodes, the system comprising:
an application release for the software application, the application release generated and executed on a central server associated with an entity;
the cluster of quantum computing nodes for hosting the application release;
the central server configured for:
combining application data including application source code and application architecture associated with the application release into an application bundle;
converting the application bundle into a data image, the data image being a snapshot of a present state of an operating system (“OS”), the OS managing the software application;
executing an image diffusion routine on the data image, the image diffusion routine encrypting the application data;
storing the data image in a database;
allocating the cluster of quantum computing nodes for hosting the application release;
entangling the cluster of quantum computing nodes into an entangled state;
releasing the data image to a first quantum computing node, wherein the releasing automatically propagates the data image to each of the quantum computing nodes in the cluster;
after the application release, monitoring application events associated with the application release; and
when an anomaly is identified at a quantum computing node from the cluster of quantum computing nodes:
retrieving the data image from the quantum computing node;
executing a reverse diffusion routine on the data image in order to access and repair the application data;
following the executing, extracting the application data;
remediating a portion of the application source code, the portion comprising the anomaly;
converting the application data into a second data image;
re-executing the image diffusion routine on the second data image; and
releasing the second data image to one of the quantum computing nodes, wherein the releasing automatically propagates the second data image to each of the quantum computing nodes.

12. The system of claim 11 wherein the central server is in communication with each of the quantum computing nodes.

13. The system of claim 11 wherein the quantum computing nodes are disentangled when the anomaly is identified.

14. The system of claim 11 wherein the second data image overwrites the data image.

15. The system of claim 11 wherein, when the anomaly is identified at the quantum computing node, a state of the application release at the quantum computing node is broken.

16. The system of claim 15 wherein, when the state of the application release at the quantum computing node is broken, the state of the application release at each quantum computing node is also broken.

17. The system of claim 11 wherein each quantum computing node comprises:
a quantum processing unit, the quantum processing unit comprising quantum logic and a quantum register; and
a controller interface configured for enabling information to be transmitted and received between the quantum processing unit and a silicon-based computing device.

18. A method for maintaining consistency in an application release for a software application and performing high-speed repair across a cluster of quantum computing nodes, the method comprising:
combining application data including application source code and application architecture associated with the application release into an application bundle;
converting the application bundle into a data image, the data image being a record of an operating system (“OS”) in its present state;
executing an image diffusion routine on the data image, the image diffusion routine encrypting the application data;
storing the data image in a database;
allocating the cluster of quantum computing nodes for hosting the application release;
entangling the cluster of quantum computing nodes into an entangled state;
releasing the data image to a first quantum computing node, wherein the releasing automatically propagates the data image from the first quantum computing node to a subsequent quantum computing node in the cluster;
after the application release, monitoring application events associated with the application release; and
when an anomaly is identified at a quantum computing node from the cluster of quantum computing nodes:
retrieving the data image from the quantum computing node;
executing a reverse diffusion routine on the data image in order to access and repair the application data;
following the executing, extracting the application data;
remediating a portion of the application source code comprising the anomaly;
converting the application data into a second data image;
re-executing the image diffusion routine on the second data image; and
releasing the second data image to the quantum computing node, wherein the releasing automatically propagates the second data image from the quantum computing node to the subsequent quantum computing node.

19. The method of claim 18 wherein the releasing the data image further comprises automatically propagating the data image from the subsequent quantum computing node to each of a remaining quantum computing nodes in the cluster of quantum computing nodes.

20. The method of claim 19 wherein the releasing the second data image further comprises following the propagating the second data image to the subsequent quantum computing node, automatically propagating the second data image to each of the remaining quantum computing nodes in the cluster of quantum computing nodes.
